(19) United States
(12) Patent Application Publication
(10) Pub. No.: US 2007/0282846 A1
(43) Pub. Date: Dec. 6, 2007

(54) System and Method for Securely Partitioning a Media Library

(75) Inventors: Dominic John GOODWILL, Kanata (CA); Anoop NANNRA, Orleans (CA)

Correspondence Address: OGILVY RENAULT LLP, 1981 MCGILL COLLEGE AVENUE, SUITE 1600, MONTREAL, QC, H3A2Y3, US

(73) Assignee: NORTEL NETWORKS LIMITED, St. Laurent (CA)

(21) Appl. No.: 11/420,967

(22) Filed: May 30, 2006

(51) Int. Cl. G06F 17/30

(52) U.S. Cl. 707/10

(57) ABSTRACT

A system and method for securely partitioning a media library of a media-on-demand system is provided. Middleware instances are created for each user group defined in the media-on-demand system. Users or clients that are part of a particular user group can only access content that has been registered with the associated middleware instance. A common media server can service multiple middleware instances reducing hardware resources and administration costs. Only content that has been registered with the middleware associated with a particular user group is viewable by the user thus providing a more secure media library.

### TECHNICAL FIELD

The present invention relates to media-on-demand libraries and systems and methods for securely partitioning libraries to restrict media access.

### BACKGROUND OF THE INVENTION

On-demand content delivery systems have been have traditionally associated with video-on-demand (VoD) systems deployed in the consumer market to provide consumers access to video content such as television and movies. The growth of broadband networks and media capable devices has enabled on-demand systems to encompass a broader range of multimedia content.

IPTV (Internet Protocol Television) is an example of an on-demand technology that facilitates access a wide range media. IPTV describes a system where a digital television service, and other media services, are delivered to subscribing consumers using the Internet Protocol over a broadband connection. IPTV and other similar technologies allow access to a wide range of media, not just video, and may be categorized as media-on-demand (MoD) systems. MoD systems such as IPTV are also growing in the corporate or enterprise environment. Businesses may use on-demand services for delivering corporate communications and training to the desktop more effectively than before.

In MoD systems when content or assets are requested from a user/client, the content is streamed from a media library to the user over a broadband network infrastructure. The broadband network infrastructure may encompass a range of communications networks such as for example cable, telephone or wireless (mobile and fixed) networks.

FIG. 1 shows a typical MoD system as known in the art. It should be understood that the MoD system described herein is for purposes of illustrating known MoD systems and that alternate network configurations and communication flows may also be utilized. In the figures, solid arrows indicate flow of content, and dashed arrows indicate flow of control information, metadata, entitlement information.

The MoD system comprises a media source 10 which provides the content for the network. The media source 10 may be a broadcaster, movie studio, music distributor, media distributor, content aggregator or any form of content generator or content provider. In an enterprise environment the content source may be training videos, presentations, or corporate communications. The administrator 50 controls ingestion of the content into the network. The media source 10 may also comprise a catcher, which is a device for delivery of media and metadata into the rest of the MoD system. In addition, the media source 10 may also include a media delivery transport system, comprising terrestrial networks, satellite networks, postal networks or motor vehicles. Availability of new content in the media source 10 is communicated with an administrator 50 of the MoD system. The administrator determines if the content should be ingested into the network and informs middleware 40 that new content is available. Middleware 40 consists of software agents acting as an intermediary between different application components required to deliver media to the user/client 60.

The middleware 40 requests metadata from the media source 10 or alternatively the administrator provides the metadata to the middleware 40. Metadata provides information about the media such as program type, length, ratings, description such as text or images, format and bandwidth. Metadata is utilized in any programming menu or directory, or for providing content specific information relevant to the transport and handling of the content by a control system.

Middleware 40 commences the ingestion process by informing an encryption & entitlement manager 20 that content is available and should be ingested. The encryption & entitlement manager 20 creates the appropriate entitlement policy or credentials for the media which define the availability and usages of the content allowed by the user/client.

The content is then sent from the media source 10 to the encryption & entitlement manager 20. At this stage the content may or may not be encrypted depending on the means by which the content provider supplies the content to the MoD system. Encryption may be performed by various methods as known in the art dependent on the type of media, such as audio or video or by distribution restrictions.

For illustrative purposes the encryption & entitlement manager 20 is shown as a single object, however, a person of ordinary skill in the art would understand that the functionality of the encryption & entitlement manager 20 can be performed by separate or dedicated access control hardware providing encryption and DRM functionality. Entitlement may also encompass known digital rights management (DRM) system. The content is then stored on the media server 30.

The middleware 40, provides the content information such as a programming menu to the user/client 60. The user/client 60 presents the information by a number of means such as for example by menus or directories. The middleware 40 filters the menu/directory to advertise only content authorized for the user/client 60. Methods of representing the menu/directory information include HTML, XML and other methods. Methods of delivery include the middleware 40 pushing the menu/directory information to the user/client 60, or the user/client requesting the menu/directory information, or the user/client performing a search for information on the middleware.

In order to access the media server 30 and the content contained therein, the user/client 60 sends a request via the middleware 40 through the broadband network 55. Once appropriate entitlement information is provided to the user/client 60 via the middleware 40, the content can then be streamed from the media server 30 to the user/client 60.

In the above described example, the user/client 60 can potentially access all of the content on the media server 30 by virtue of the network structure. The middleware 40 must be aware of all content registered on the server and therefore potentially enable unauthorized access to the content. In order to control user access, control methods based upon user permissions are known in the art. Methods of hiding content by means of user permissions or flags, associated with specific media content, based upon user subscriptions have been utilized in non-media content environments. For example, such as to keep general users away from operating system files on a personal computer or computer network, or in a business environment to restrict access to corporate data to approved users. However, with these methods the content, although not necessarily viewable, is potentially accessible by hacking by users having access to the network.

The menu/directory presented to the user/client must be filtered to show only content authorized to be accessed by user/client based upon the associated flags. The fact that all of the content is potentially accessible if the permissions or flags are bypassed increases the possibility for hacking and unauthorized access into the media library raising security concerns.

An alternate approach for providing security is to have separate media servers, in essence duplicating part of the MoD system to restrict access. However, this duplication of hardware and administration increases overall operating cost of the system. In addition, it is difficult to provide mechanisms to allow the access permissions to be changed on any content already ingested into the system. In the enterprise environment, content security may be of particular concern as unauthorized access to content may have wider ranging implications than just piracy.

Accordingly, systems and methods that enable a media-on-demand library to be securely partitioned remain highly desirable.

### SUMMARY OF THE INVENTION

The present invention is to provides systems and methods for securely partitioning libraries to restrict media access.

Middleware instances are defined for each user group in the media-on-demand system. Users or clients that are part of a particular user group can only access content that has been registered with the associated middleware instance. A common media server can service multiple middleware instances reducing hardware resources and administration costs. Only content that has been registered with the middleware associated with a particular user group is viewable by the user/client thus providing a more secure media library. The middleware instance directs creation of entitlement policies for the content by and entitlement manager. If the content stored in the library is encrypted, the entitlement manager may also encompass encryption if required. The encryption and entitlement manager provided the appropriate entitlement to the user/client and decryption keys once access had been authorized and allowed by the assigned middleware instance. Ingestion of streaming media into the library may be controlled by one of the middleware instances. Entitlement may also be generated by one of the middleware instances or may be created individually for each middleware instance.

Thus, an aspect of the present invention provides a method of partitioning a media-on-demand library. A plurality of user groups are defined each associated with a middleware instance. Streaming media content of the library is registered with at least one of the plurality of middleware instances and requests from a user are directed to the appropriate middleware instance.

A further aspect of the present invention provides a method of providing access to a media-on-demand library. The method comprises receiving a request from a user at one of a plurality of middleware instances for streaming media content stored in the media-on-demand library. Verifying at the one of the plurality of middleware instances that the user requesting the streaming media content is part of a user group associated with the middleware instance and providing to the user an entitlement policy to the streaming media content.

Yet a further aspect of the present invention is provides for a media-on-demand system comprising a library containing streaming media content. A plurality of middleware instances, each instance being associated with a respective user group, at least part of the streaming media content is registered with each of the plurality of middleware instances. Wherein users of the user groups can only access content registered with the respective middleware instances.

Other aspects and features of the present invention will become apparent to those ordinarily skilled in the art upon review of the following description of specific embodiment of the invention in conjunction with the accompanying figures.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating a media-on-demand system as known in the art;

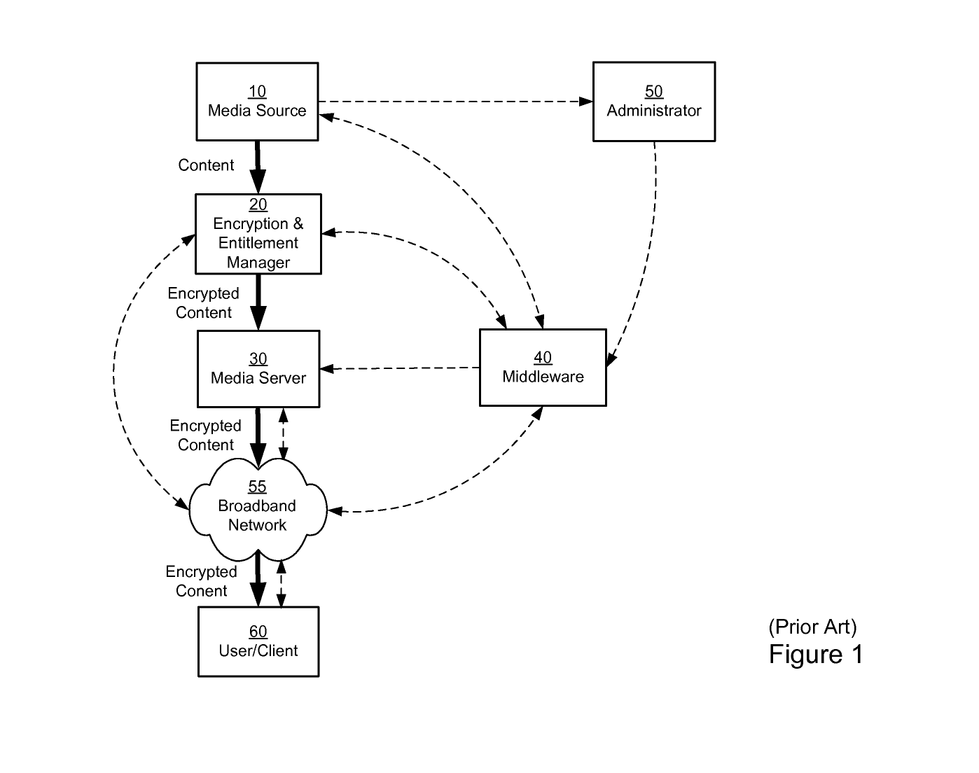

FIG. 2 is a block diagram schematically illustrating a media-on-demand system in accordance with an embodiment of the present invention;

FIG. 3 is a flow diagram of how content is ingested into the media-on-demand system as shown in FIG. 2 in connection with an embodiment of the present invention; and

FIG. 4 is a flow diagram of how content is accessed by a user/client from the media-on-demand system as shown in FIG. 2 in connection with an embodiment of the present invention.

It will be noted that throughout the appended drawings, like features are identified by like reference numerals.

### DETAILED DESCRIPTION OF THE PREFERRED EMBODIMENT

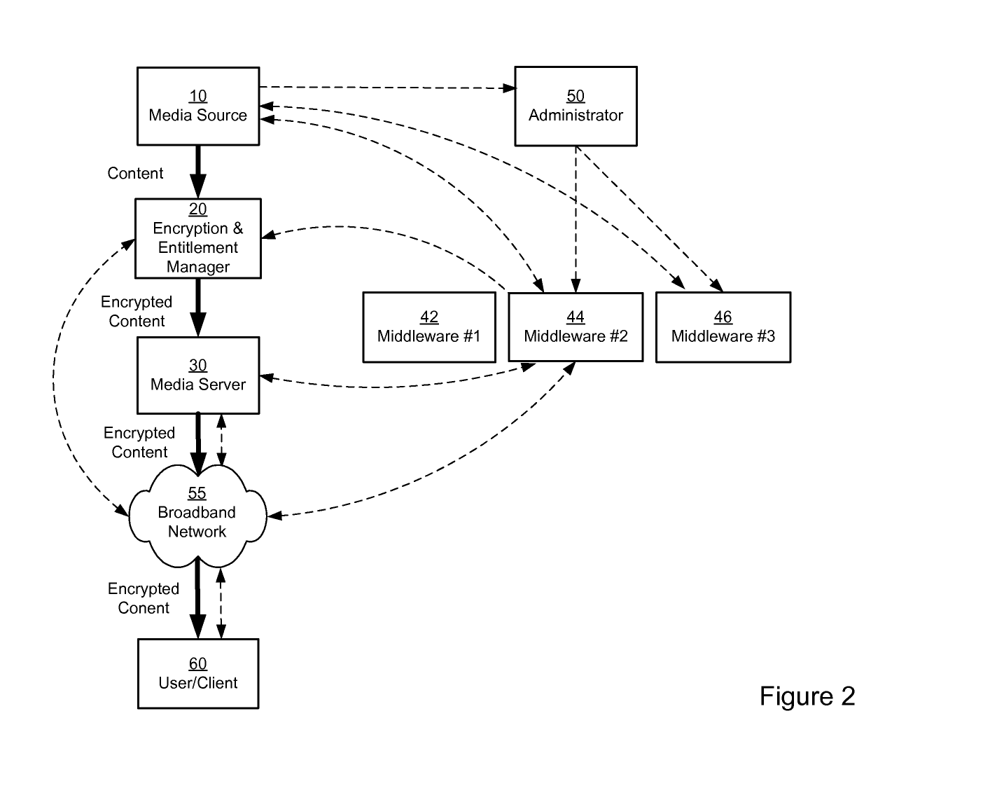

The present invention provides system and methods that enable media-on-demand library to be partitioned to ensure secure access to assets of the media library. Embodiments of the present invention are described below, by way of example only, with reference to FIGS. 2-4.

The present invention provides for securing a media library of a media-on-demand (MoD) system by defining unique middleware instances for user groups. Users or clients that are part of a particular user group can only access content that has been registered with the associated middleware instance. The media library resides on a common media server which can service multiple middleware instances reducing hardware resources and administration costs. The media server may comprise a plurality of clusters, wherein each cluster comprises a plurality of hardware and software devices for storing the media.

A user/client can only request content from the associated middleware instance to which it is granted access. The middleware also provides the interface to the MoD system for the user/client and controls access to content. In addition, middleware facilities features such as network monitoring and billing.

When a request for content from the user/client is received at the middleware instance, the middleware requests entitlement from an entitlement manager. The entitlement manager may include an encryption engine if required. The encryption & entitlement manager provides credentials or decryption keys to the user so that the content can be decrypted. The decryption key for a given media asset is common for all the user groups. The entitlement would generally be common for all user groups, but in principle could be different for each user group. For example, user group 1 might be entitled to watch a movie, where as group 2 would be entitled to watch and record the movie. Once entitlement has been provided the user can then request that the content be streamed from the media server and decrypt the content. Entitlement and encryption have been identified as one system for illustrative purposes. A person of ordinary skill in the art would understand that entitlement and encryption may be implemented separately by various methods.

Multiple middleware instances are created dependent on the number of user groups defined by the administrator. Each middleware instance may correspond to a class of user with a different subscriptions, but have access to shared media servers, digital rights servers and authentication servers.

The media may be streamed to the user/client by any number of protocols such as Motion Picture Experts Group Transport Stream (MPEG-TS), Motion Picture Experts Group Program Stream (MPEG-PS), Hypertext Transfer Protocol (HTTP), Multimedia Message Service (MMS), Real Time Transport Protocol (RTP), Real Time Streaming Protocol (RTSP), Real Time Control Protocol (RTCP) or proprietary protocols for example Real Networks Real Data Transport (RDT) or Windows Media Advanced Streaming Format (ASF) depending on the system architecture.

It should also be understood that the media-on-demand system may be resident on a single network or have components distributed to other adjoining networks. For example, the media server 30 may be located on a different network separate from the encryption & entitlement manager 20. The media server 30 may comprise one or more clusters of hardware and software devices that may act together to store media and to deliver requested content.

FIG. 2 illustrates MoD system in accordance with an embodiment of the present invention. In this embodiment there are three user groups or classes, known as #1, #2, #3, but the invention should be understood to include embodiments with any number two or more of user groups or classes. The administrator 50 creates a middleware instance for each user group or class defined in the MoD system. In this example, three middleware instances (42, 44 & 46) are shown to represent three distinct user groups. The user groups may be based upon characteristics such as subscription levels defined by pricing, service offerings, or capabilities of the access device or access network. Alternatively, in an enterprise MoD environment, the groups may be defined for organizational classes such as for example managers, helpdesk staff and human resources.

Each of the middleware instances can access the shared resources of the system such as the encryption & entitlement manager 20 and media server 30. The users/clients 60 of the system only have access to the particular middleware #1, #2 or #3 (42, 44 & 46) instance associated with their associated user group providing control over the content that is available to the users.

Alternatively, the user/clients 60 may not be restricted to a single middleware instance but may be granted access different middleware instances to access different content types or content provider. The user/client 60 would log into a particular middleware instance to access content associated with the respective middleware instance.

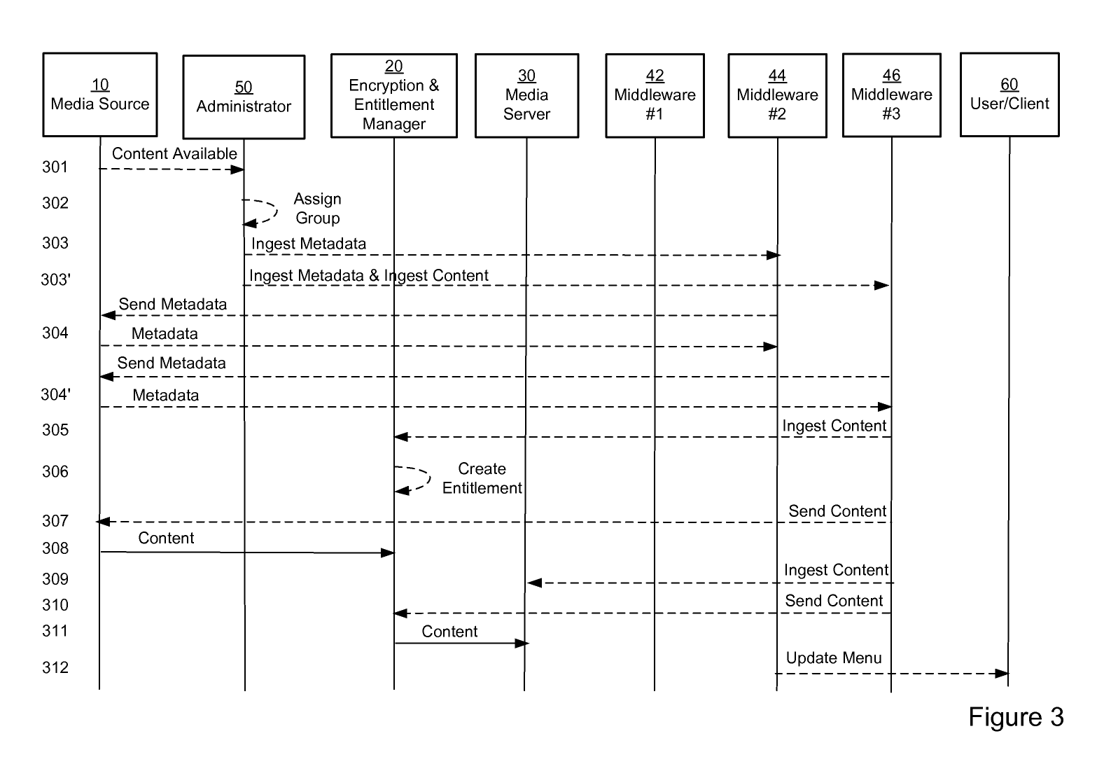

Referring also to FIG. 3, when new content is available the administrator 50 is informed by the media source 10 by a content available message or advertisement at step 301. The administrator 50 must make a determination as to which user groups will have access to the media. The determination involves the application of rules such as business rules which may for example be determined by subscriptions or content pricing in a consumer environment or defined by business groups or management levels in a business or enterprise environment. In this example, the user groups associated with middleware#2 44 and middleware#3 46 are identified as required to have access to the content. The administrator assigns the classes to the content at step 302 for registration with the desired middleware instance. Each related middleware instance, middleware#2 44 and middleware#3 46 are informed that the content is available and that the metadata is provided at step 303 and 303′ respectively.

The ingestion of the content into the MoD system must then be initiated by one of the middleware instances which can be determined by a various methods. For example, the lowest identified (numbered) middleware instance may be responsible for initiating content ingestion. The command may be provided as part of the metadata at step 303′ to middleware#3 46 or issued separately. The selected middleware, middleware#3 46, sends an ingest content message at step 305 to the encryption & entitlement manager 20.

Registration continues with each middleware instance then sends a request to the media source for the metadata associated with the content and the media source provides the metadata at steps 304 and 304′. It should also be understood that metadata may be provided alternatively by the administrator 50 directly rather than the media source either at steps 303 and 303′ or steps 304 and 304′.

The encryption & entitlement manager 20 creates entitlement policies for the specific content at step 306. Separate entitlement polices may be created for each middleware instances. The entitlement policy defines the rights period to access the content in addition to defining what can be done with the content such as recording or copying. The rights period may be a defined by parameters such as hours of availability, length of time that the content is available such as 24 hours or number of viewings allowed. For example, users/clients accessing middleware#2 44 may be able to only view the content, where as users/clients accessing middleware#3 46 may be able to view and record content which would require a different entitlement policy. Therefore, step 306 may receive additional requests from middleware#2 44 and middleware#3 46 prior to step 306 for creation of middleware specific entitlement policies.

Alternatively the administrator 50 may define the entitlement policies directly with the entitlement & encryption manager 20. In addition, the encryption & entitlement manager 20 may provide a more general entitlement to some or all of the media library, at some earlier time, such as when the user/client 60 logs into the middleware 40. In an embodiment, the middleware 40 can instruct the encryption & entitlement manager 20 to deliver appropriate entitlement information to the user/client 60, after the middleware 40 has approved the request for a particular media asset.

The middleware#3 46 then sends a request to the media source to send the content at step 307. The content is sent at step 308 to the encryption & entitlement manager 20. The media server 30 is then sent a request by the middleware#3 46 to ingest the content at step 309 and the encryption & entitlement manager 20 is requested to send the content at step 310 to the media server. The content is encrypted and sent at step 311 from the encryption & entitlement manager 20 to the media server 30. In another embodiment the encryption & entitlement manager 20, may be distributed or located after the media server 30. Content would then be encrypted as it is streamed in real-time to the user/client.

It should also be understood that the ingest content message may be sent from the middleware to the media source 10, as an instruction for the media source to push the content into the MoD system.

In this example the client/user may be part of a user group associated with middleware#2 44. Availability of the new content is then advertised to the user/clients 60 through the broadband network 55 by the middleware#2 44 by an update menu message at step 312 via a menu or directory update. The menu may be simply a directory displayed to the user of available content or take the form of a programming guide or searching interface.

Accordingly, the user/client associated with the middleware#3 46 that was used to ingest the content may now access the content; a user/client associated with the middleware#2 44 that ingested the metadata but was not used to ingest the content may now also access the content; but a user/client associated with middleware#1 42 will remain unaware of the content and will not be able to access or request the content.

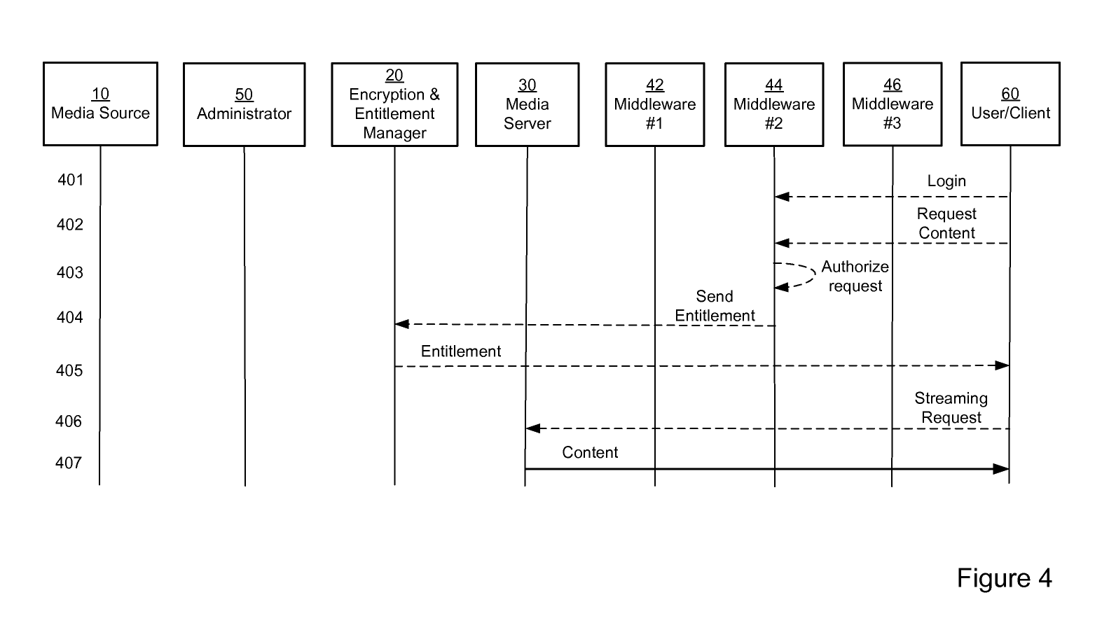

FIG. 4 shows how a client/user 60 would access content stored on the media server 30. The user/client 60 may be embodied in dedicated hardware such as a set-top box or by software residing on any broadband communication access device such as a personal computer or mobile phone able to access a broadband network 55. The login procedure may require user input comprising some form of identification or a password through the broadband network 55 to provide an added level of security.

At step 401 the client 60 must login to the middleware#2 44 to access the on-demand system. The client then sends a media request at step 402 to the middleware#2 44. The media request may be a request for a specific piece of content such as a video program. The middleware#2 44 authorizes the request at step 403. The authorization of the request may include communication with an authentication system (not shown). At step 404 the middleware 40 then sends an entitlement authorization to the encryption & entitlement manager 20. The encryption & entitlement manager 20 provides entitlement keys or certificates at step 405 which allow the user/client 60 to access and decode the requested content.

The entitlement may be defined for s specific period of time, for example allowing a program to be viewed for limited period, such as 24 hours. Entitlement may also include identification of what the user/client can do with the content such as playback, record, copy or moved to other devices.

The user/client 60 can then send a streaming request at step 406 to the media server 30 which will then stream the required content to the user/client 60 at step 407. If the user/client 60 requests content from a middleware instance which is it not defined as part of the user group, for example middleware#1 42 or middleware#3 46, the request will be denied. The request to access content cannot be spoofed because middleware#1 42 does not know about the content an cannot generate a legal send entitlement request to the encryption & entitlement manager 20 to access the content.

The user/client 60 may unlock or access the content only after reception of associated certificate or key sent by the encryption & entitlement manager. The certificate or key is only sent when the encryption & entitlement manager 20 is instructed to do so by the associated middleware. The middleware effectively controls access to the content as the respective user groups are only aware of content registered with the respective middleware instance. Flags or permissions do not have to directly associated with the content allowing the content stored on the media server to be administered more easily from a shared resource.

In another embodiment, the user/client 60 requests for content at step 402 made via the middleware instance may be performed by securing dialogs facilitated by the encryption & entitlement manager 20 or an authentication server (not shown). Further, the middleware instances 42, 44, 46 and the encryption & entitlement manager 20 may be associated with an authentication server (not shown). The authentication server would be used to secure the entitlement authorization message at step 404. Thus, advantageously, a chain of trust is established: the content is secured by certificates and keys held in the encryption & entitlement manager 20; the user/client 60 is authenticated with the authentication server to make content requests 402; the middleware instances are authenticated with the authentication server to send entitlement requests 404; and the content may be unlocked only by the certificates and keys sent by the encryption & entitlement server 20. In this manner, the send entitlement message 404 cannot be spoofed by an unauthorized user or hacker.

In an alternative embodiment, multiple administrators 50 may be defined for the MoD system. Each administrator is involved in the flow only for assets for which they are authorized to manage. Unique media sources may be associated with individual administrators and middleware instances. The middleware instances may also be controlled by multiple administrators to provide access to the media assets dependent on the network configuration. The embodiment would be applicable where specific administrators are directly responsible for specific content providers available to the users of the MoD system.

The embodiments of the invention described above are intended to be illustrative only. The scope of the invention is therefore intended to be limited solely by the scope of the appended claims.

We claim:

1. A method of partitioning a media-on-demand library comprising the steps of:
defining a plurality of user groups;
defining a plurality of middleware instances, each instance associated with one of the plurality of user groups;
registering streaming media content of the library with at least one of the plurality of middleware instances;
directing a request from a user to the appropriate middleware instance; and
wherein the user can only access content registered with the middleware instance of the respective user group.

2. The method of claim 1 wherein the step of registering the streaming media content further comprises the step of ingesting streaming media content into the media-on-demand library under the direction of a selected one of the plurality of middleware instances.

3. The method of claim 2 further comprising the step of creating one or more entitlement policies to the streaming media content under the control of the selected one of the plurality of middleware instances.

4. The method of claim 2 further comprising the step of creating an entitlement policy to the streaming media content for each of the plurality of middleware instances, wherein the creation of each entitlement policy is performed under the control of the respective middleware instance.

5. The method of claim 2 wherein the step of ingestion further comprises encrypting the streaming media content before storing the encrypted content in the library.

6. The method of claim 1 wherein the step of directing a request to the middleware instance further comprises authenticating the user identity and middleware instance by an authentication server.

7. The method of claim 1 wherein the step of registering further comprises receiving metadata associated with the streaming media content.

8. The method of claim 1 wherein individual administrators are assigned to each one of the plurality of middleware instances and each middleware instances is associated with streaming media from unique content sources.

9. A method of providing access to a media-on-demand library, the method comprising the steps of:
receiving a request for streaming media content stored in the media-on-demand library from a user at one of a plurality of middleware instances;
verifying at the one of the plurality of middleware instances that the user requesting the streaming media content is part of a user group associated with the middleware instance;
providing to the user an entitlement policy to the streaming media content; and
wherein the user can only access content registered with the respective middleware instance.

10. The method of claim 9 further comprising the step of streaming the requested streaming media content from a media server to the user.

11. The method of claim 9 wherein the step of verifying further comprises authenticating the credentials of the one of the plurality of middleware instances with an authentication server.

12. The method of claim 9 wherein the step of providing to the user the entitlement policy, further comprises providing a decryption key to decrypt the streaming media content.

13. The method of claim 9 wherein the entitlement policy is unique to the respective middleware instance.

14. A media-on-demand system comprising:
a library containing streaming media content; and
a plurality of middleware instances, each instance being associated with a respective user group, at least part of the streaming media content is registered with each of the plurality of middleware instances, and wherein users of the user groups can only access content registered with the respective middleware instances.

15. The system of claim 14 further comprising an entitlement manager for providing an entitlement policy to users of the user group of the respective middleware instance to access streaming media content.

16. The system of claim 15 wherein a selected one of the plurality of middleware instances controls the ingestion of streaming media content into the library and controls creation of entitlement policies.

17. The system of claim 15 wherein a selected one of the plurality of middleware instances controls the ingestion of the streaming media content in to the library and each of the plurality of middleware instances controls creation of their respective entitlement policy.

18. The system of claim 14 further comprising an encryption manager for encrypting the streaming media content and providing decryption keys to the users associated with respective plurality of middleware instances.

19. The system of claim 15 further comprising an authentication server for authenticating the credentials of middleware instances and users.

20. The system of claim 14 wherein the library further comprises common media servers accessible by all of the plurality of middleware instances.
